(19) United States
(12) Patent Application Publication
(10) Pub. No.: US 2002/0188378 A1
(43) Pub. Date: Dec. 12, 2002

(54) Vending machine wireless point of sale inventory system

(76) Inventor: Davin Sufer, Toronto (CA)

Correspondence Address: OGILVY RENAULT, 1981 MCGILL COLLEGE AVENUE, SUITE 1600, MONTREAL, QC, H3A2Y3, CA

(21) Appl. No.: 10/166,186

(22) Filed: Jun. 11, 2002

Related U.S. Application Data
(60) Provisional application No. 60/297,254, filed on Jun. 12, 2001.

(51) Int. Cl. G06F 17/00

(52) U.S. Cl. 700/236

(57) ABSTRACT

An apparatus and method for recording sales operations of a vending machine at the vending machine and for transferring the sales operations to a remote operator. The apparatus comprises sensor devices adapted to be mounted to a vending machine for signaling sales operations of the vending machine. A controller is connected to the sensor devices for recording sales operations data of the vending machine by receiving sales operations signaling from the sensor devices. The controller comprises an output emitter device for transferring the recorded sales operations data to a remote operator through a communications link therewith. A communications device is provided for establishing the communications link between the controller and the operator.

### BACKGROUND OF THE INVENTION

1. Field of the Invention

The present invention relates to vending machines and, more particularly, to an on site wireless inventory system for use therewith.

2 Description of the Prior Art

Growth and efficiency limitations are numerous in the vending machine industry. One such limitation is due to the fact that each vending machine is, in a sense, an isolated salesman. There is no register or any accurate real-time counter of what each machine is selling. Any calculation or estimate achieved to predict the sales would have a large degree of error, and it is not economical to sacrifice the time and effort to keep track of individual items. A second limitation in the vending machine business is that many of the machines are physically abused, which results in either malfunctions of the machine or the complete shut down thereof. While these malfunctions are usually easily repaired, lost sales result from the downtime. Such limitations restrict the proper functioning as well as the potential growth of the vending machine industry.

These limitations make it quite difficult for the operator to run an efficient business and to grow. This lack of sales data increases both the possibility of theft by employees and the amount of manpower needed for inventory control, and also leads to lost sales. Quite often, the operator has employees restocking the machines and emptying the money boxes. As the company expands and more employees are hired, theft becomes an increasing problem. Sales are difficult to monitor with precision unless being constantly tracked, and thus the possibility of theft is increased. Once a company reaches the point where several employees are working full time at restocking machines, the amount of data to be tracked becomes enormous and the amount that can be stolen or lost unnoticed is quite considerable.

Furthermore, since there is no form of communications with the vending machine, the operator knows what was sold only after having an employee visit the vending machine. Inventory control becomes increasingly difficult, resulting in a non-efficient inventory control system. Operators usually rely on educated guess work or employee availability to schedule restocking of the vending machine. Once the employee arrives on site, the machine is either understocked or still has plenty of stock. Either scenario is inefficient since it results in lost sales or wasted manpower.

It would be desirable to provide a system enabling an operator to communicate with the vending machine at any point in time in order to easily access the crucial sales data. The operator could thus be notified of failures in the machine, avoiding calls from angry customers and lost sales during downtime. The risk of theft would drastically be reduced as the vending machine operator may gather constant statistical data on how much was sold at every single vending location. Such a system would supply the vending machine operators with a real-time inventory status, thereby providing a great improvement on the previous inventory refurbishing based on guess work.

Therefore, systems have been provided in order to achieve offside communication with vending machines. For instance, U.S. Pat. No. 4,766,548, issued on Aug. 23, 1988 to Cedrone et al. discloses a microprocessor monitoring and periodically reporting on data pertinent to the commercial operation of a reporting system, such as a soft drink vending machine, to a central data collection monitoring computer. Information gathered by the microprocessor is transmitted to the central computer via telephone lines using DTMF signals produced by the microprocessor.

Although the above described patent discloses a communications system allowing to access the inventory of vending machines from a distance, it involves connecting vending machine inventory systems to telephone lines on site. This poses a problem as the proprietor of the vending machines often differs from the building proprietor, whereby it may not be possible nor desired to supply telephone lines to the vending machines. Furthermore, the information may only be accessed through the central data collection monitoring computer.

U.S. Pat. No. 6,115,649, issued on Sep. 5, 2000 to Sakata discloses a vending machine and a distribution management system using a CPU within the vending machine for controlling the commands thereof. This patent mentions the monitoring of sales for inventory control, the verification of the inventory status by an operator and the communications link between the vending machine and the distribution management system. However, even though these functions are mentioned, the method for achieving these is not described.

U.S. Pat. No. 5,207,784, issued on May 4, 1993 to Schwartzendruber describes a vending machine with a sales monitoring system, whereby a plurality of optical sensors are disposed therein in order to monitor the activity of the vending machine. In this patent, telephone lines are disclosed as a preferred embodiment, although mentioning other systems such as cellular phone technology. Once more however, the information is stored in an inventory control center distant from the vending machines.

U.S. Pat. No. 5,844,808, issued on Dec. 1, 1998 to Consmo discloses an apparatus and method for monitoring and communicating with vending machines, the apparatus being connected to a radio modem as communications system. The apparatus of this patent reads the push button signals of the vending machines and the information is recorded by a personal computer at a receiving end.

A few of the above described patents involve a central computer recording the information at a receiving end. In order for such systems to be affordable, a substantial amount of vending machines must be monitored by the central computer. Thus, it is believed that these patents are unaffordable by small and medium-scale operators. Furthermore, vending machine operators are often in displacement between machines. Therefore, returning to a central computer for having real-time inventory information presents additional travelling and represents an obstacle in the optimization of vending machine operations.

### SUMMARY OF THE INVENTION

It is therefore an aim of the present invention to provide a vending machine wireless inventory system adaptable for use by large-scale operators, while being affordable by small-scale operators.

It is also an aim of the present invention to provide a vending machine wireless inventory system using public switched telephone network (PSTN) and recording inventory information on site such that an operator may access this information from any telephone.

It is a further aim of the present invention to provide a vending machine wireless inventory system which may be retrofitted to older vending machines.

Therefore, in accordance with the present invention, there is a method for transferring recorded sales operations data of a vending machine to a remote operator, comprising the steps of (i) detecting, at at least one vending machine, sales operations and recording sales operations data of said vending machine; (ii) answering a call signal from an operator; and (iii) transferring said sales operations data of at least one rack of said vending machine to said operator.

Further in accordance with the present invention, there is provided an apparatus for recording sales operations of at least one vending machine at said at least one vending machine and for transferring the sales operations to a remote operator, comprising sensor devices adapted to be mounted to a vending machine for signaling sales operations of the vending machine; a controller connected to said sensor devices for recording sales operations data of the vending machine by receiving sales operations signaling from said sensor devices, said controller comprising an output emitter device for transferring the recorded sales operations data to a remote operator through a communications link therewith; and a communications device for establishing the communications link between said controller and the operator.

Still further in accordance with the present invention, there is provided an apparatus for recording sales operations of at least two vending machines at one of said at least two vending machines and for transferring the sales operations to a remote operator, each of said at least two vending machines having a control system recording sales operations of a respective one of said at least two vending machines, comprising a controller connected to each said at least two vending machines for recording sales operations data of said at least two vending machines by receiving sales operations signaling from said at least two vending machines, said controller comprising an output emitter device for transferring the recorded sales operations data to a remote operator through a communications link therewith; and a communications device for establishing the communications link between said controller and the operator.

### BRIEF DESCRIPTION OF THE DRAWINGS

Having thus generally described the nature of the invention, reference will now be made to the accompanying drawings, showing by way of illustration a preferred embodiment thereof, and in which:

FIG. 1 is a block diagram illustrating a wireless point of sale inventory system in accordance with the present invention;

FIG. 2 is a flow chart illustrating the steps of operation of the wireless point of sale inventory system;

FIG. 3 is a flow chart illustrating the step of sensing and recording of the flow chart of FIG. 2;

FIG. 4 is a flow chart illustrating the step of establishing and entertaining a communications link of the flow chart of FIG. 2;

FIGS. 5A and 5B are tables illustrating data stored by the wireless point of sale inventory system;

FIG. 6 is a block diagram illustrating a data collecting and storing system to be used with the wireless point of sale inventory system;

FIG. 7 is a block diagram illustrating another data collecting and storing system to be used with the wireless point of sale inventory system; and

FIG. 8 is a block diagram illustrating the wireless point of sale inventory system in accordance with another embodiment of the present invention.

### DESCRIPTION OF THE PREFERRED EMBODIMENTS

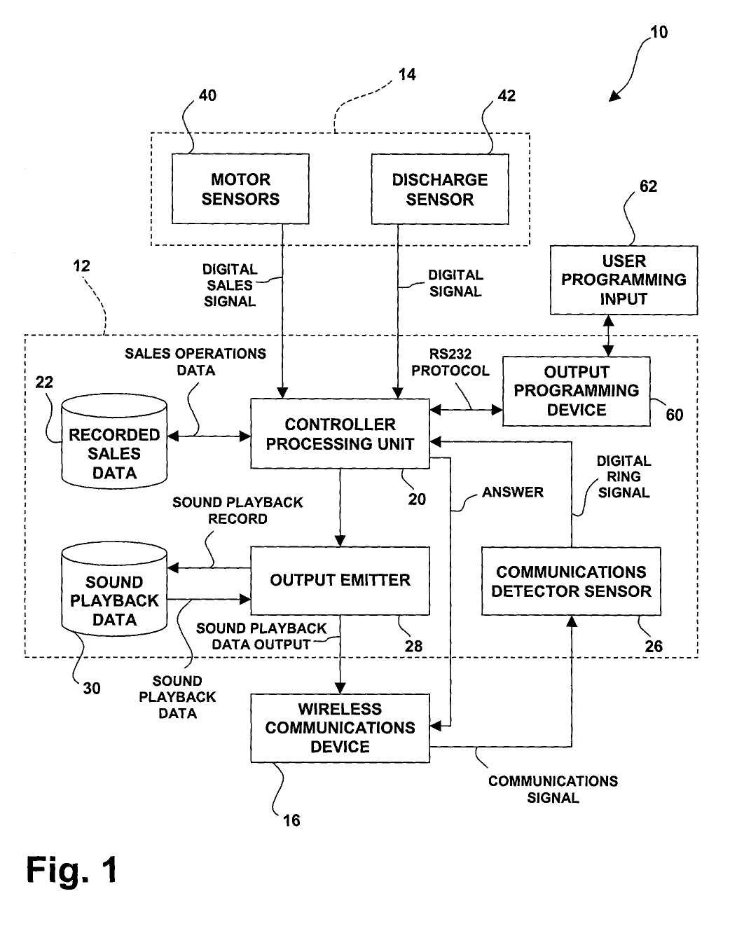

Referring to FIG. 1, a wireless point of sale inventory system (hereinafter referred to as WPOSI system) is generally shown at 10 and comprises a controller 12, sensor devices 14 and a wireless communications device 16. The WPOSI system 10 is adapted for being mounted to at least one vending machine in order to record the sales operations data thereof and to transfer the recorded sales operations data to a remote operator.

The controller 12 comprises a controller processing unit 20, which controls the system 10 and coordinates its operations. These operations include establishing a communications link with a vending machine operator and recording the sales operations data of the vending machine, and transmitting relevant information to a vending machine operator. The controller processing unit 20 may typically be part of a microcontroller (e.g. EEPROM portion of a Microchip PIC16F874 device). The typical memory of such a microcontroller may consist in 8K of programmable memory, 256 bytes of EEPROM and 368 bytes of RAM. The EEPROM portion of the microcontroller is also used for recording and storing the sales operations data, as shown at 22. The use of the EEPROM memory to record sales data ensures that the data will not be lost if power to the microcontroller is lost due to a power failure or disconnection of the device. The type of information recorded and stored at 22 will be described below. Sales operations are monitored by the sensor devices 14, which comprise a plurality of motor sensors 40 and a discharge sensor 42. For instance, the motor sensors 40 may consist of optorelays (e.g. manufactured by QT) disposed on the electrical connections of each motor of a motor array of the vending machine. Typically, when a motor is actuated to discharge an item from the vending machine, a LED portion of an optorelay emits a light signal which is detected by a sensing portion of the same optorelay and sent to the controller processing unit 20 as a digital sales signal, whereby a sale is recorded and stored with the recorded sales data 22.

However, the sensor devices 14 may also include a discharge sensor 42 monitoring the discharge chute of the vending machine in order to confirm that a digital sales signal of one of the motor sensors 40 announcing a sale has resulted in a completed sale. The discharge sensor 42 may typically be a mechanical switch triggered by a falling item or an infrared beam which is broken by the falling item to send a digital signal to the controller processing unit 20. The confirmation operations of the sensor devices 14 will be described in further detail hereinafter.

Therefore, the controller processing unit 20 records and stores the sales operations data at 22 as a result of the signals incoming from the sensor devices 14. The controller processing unit 20 also controls communications between the WPOSI system 10 and a vending machine operator, whereby the latter may access the sales data 22 recorded by the former. The communications device 16 is preferably a wireless device such as a cellular phone, a PCS or a data packet radio. However a standard data modem hooked to the PSTN or an Ethernet device hooked to a LAN may be connected. Cellular phones provide an economical and versatile communications device and offer the advantage of being reachable through PSTN. The wireless communications device 16 is connected to a communications detector sensor 26 of the controller 12. In a preferred embodiment, the communications detector sensor 26 is an optorelay (e.g. QT optorelay) which receives a communications signal under the form of an electrical current resulting from the ring of the wireless communications device 16. The electric current is transformed into a light signal from a LED portion of the optorelay, and the light signal is picked up by the sensor portion of the optorelay. A signal is then sent to the controller processing unit 20 which will initiate a communications link with the wireless communications device 16. The controller 12 may connect to the available connection port on the wireless communications device 16. In any event, the controller 12 is adapted to be connected to the wireless communications device 16. In other embodiments, the communications detector sensor 26 may be a detection circuit detecting a current variation resulting from the ring of the wireless communications device 16, or detecting a pre-determined carrier signal in the case of a data packet radio transmission. If a standard or wireless modem is used, the communication device would alert the controller processing unit 20 of a communications link through the RS232 port on the device.)

Once this communications link is established, the recorded sales data 22 will be transmitted to the vending machine operator through the wireless communications device 16 by an output emitter 28 controlled by the controller processing unit 20. The output emitter 28 stores sound playback data at 30 as recorded by the operator beforehand. The output emitter 28 may typically be an ISD manufactured chip of model ISD2590/60/120 storing up to 120 seconds of audio. The controller processing unit 20 establishes a link between the sound playback data 30 and the recorded sales data 22, as will be explained hereinafter. As and example, when the wireless communications device 16 is a cellular or a PCS phone and sound playback is played into the phone, the controller 12 must have connectors that will relate it to both the audio input and output of the phone.

In order to access the programmable memory and EEPROM of the controller 12 such that an operator may program the latter and, for instance, record sound playbacks, an output programming device is provided as shown at 60, for receiving user programming input 62. The output programming device 60 may consist in a RS232 interface (e.g. Maxim Max 232), whereby the RS232 protocol is used for communications between the controller processing unit 20 and the on site operator. Another possibility is to have a tone recognition device (not shown) within the WPOSI system 10. This would allow the WPOSI system 10 to be programmed from a distance through a touch-tone telephone. Furthermore, this tone recognition device could also be used for security purposes, whereby the WPOSI system 10 could require a password to grant access to an operator to the sales data, amongst other features.

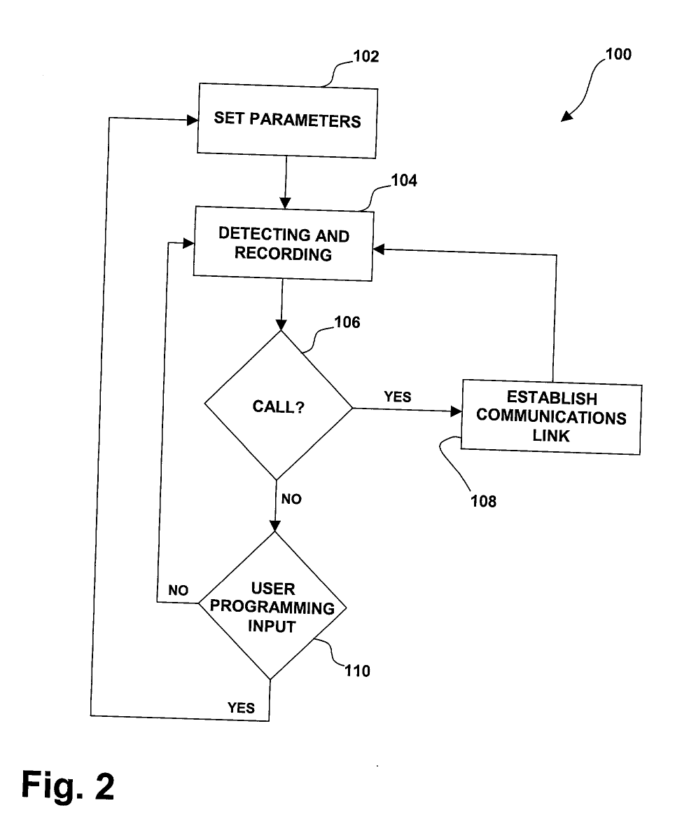

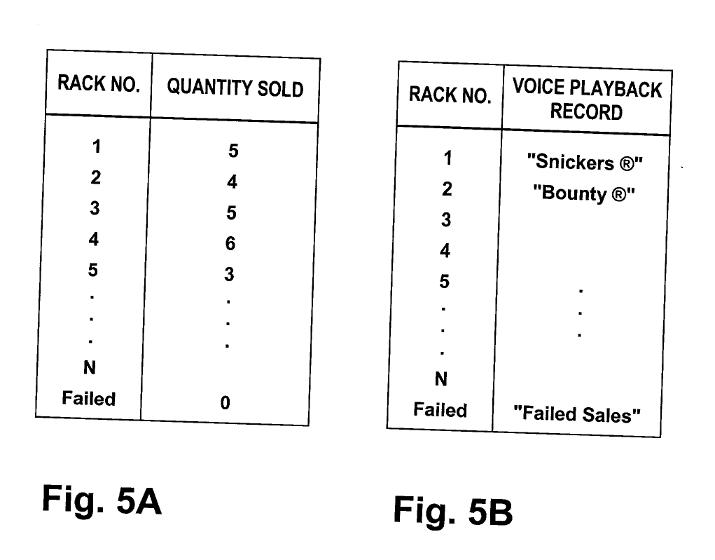

Referring now to FIG. 2, a flow chart 100 illustrates the steps of operation of the wireless point of sale inventory system 10 of the present invention. According to step 102, a vending machine operator sets the parameters of the WPOSI system 10. This is achieved by the operator programming the controller 12 by connecting a PC, a portable processor or the like to the output programming device 60. It is pointed out that this step, in the preferred embodiment, is achieved on site for security purposes. The type of information inputted to the controller 12 includes the recording of sound playback data as shown at 30 of FIG. 1. In a first embodiment of the present invention, this sound playback data consists in voice snippets identifying the racks of the vending machine to the items each sells. In another embodiment of the present invention, tones may be pre-recorded as sound playback data, for cases, as will be described below, where the sales data is transmitted to a computer rather than directly to a vending machine operator. FIG. 5B illustrates typical sound playback data which may be recorded in order to identify, for instance, racks to given chocolate bars. At step 102, the operator may also reset the recorded sales data 22 stored by the controller processing unit 20 so as to indicate that zero sales have been achieved after restocking the vending machine.

Once the above described parameters have been set, the WPOSI system 10 monitors the sales operations of the vending machine according to step 104. This is achieved by the sensor devices 14 monitoring the current lines of the motors of the vending machine. A flow chart describing the step 104 in further detail will be shown hereinafter.

According to step 106, if a communications signal is detected by the communication detector sensor 26, a communications link will be established between the operator and the WPOSI system 10 as shown at step 108, whereby data will be transmitted to the operator. A flow chart describing the step 108 will be described in further detail hereinafter. It is pointed out, however, that step 108 includes ending the communications link.

According to step 110, the sensing and recording of step 104 may also be disrupted by user programming input. If so, the WPOSI system 10 will be returning to step 102, wherein the parameters thereof will be set as described above. If not, the sensing and recording of step 104 will continue.

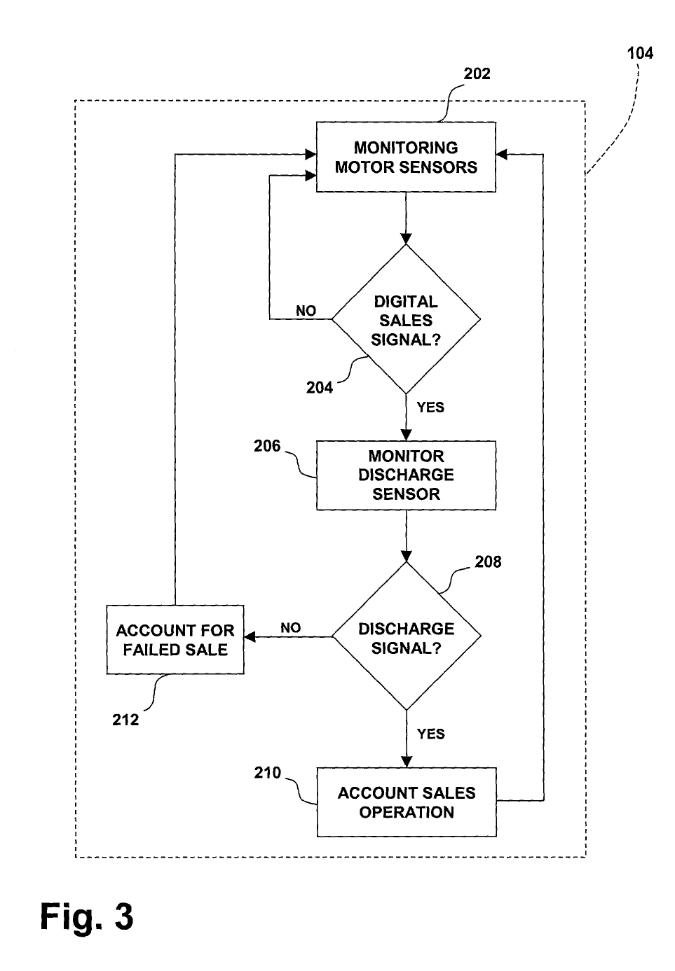

Referring now to FIG. 3, the step 104 of sensing and recording is illustrated in further detail. According to step 202, the motor sensors 40 of FIG. 1 monitor the motors of the vending machine.

According to step 204, the motor sensors will keep monitoring the vending machine in the step 104 until a digital sales signal is received through one of the motor sensors 40.

According to step 206, if a signal is received from any one of the motor sensors 40, the discharge sensor 42 will be monitored. The discharge sensor 42 may be actuated to monitor for a predetermined amount of time after a signal as been received from the motor sensors 40, such as to ensure that a sale has taken place in a short lapse of time after the signal has been monitored by one of the motor sensors 40. For instance, the discharge sensor 42 may be actuated for a time frame of 10 seconds after the digital sale signal received through the motor sensors 40.

According to 208, if the digital sales signal received from the motor sensors 40 is confirmed by a discharge signal of the discharge sensors 42, the WPOSI system 10 will reach the step 210, wherein the sales signal will be recorded and stored within the recorded sales data 22 by the controller processing unit 20. Thereafter, the WPOSI system 10 will return to the step 202 of monitoring the motor sensors 40.

According to step 212, if no discharge signal is detected by the discharge sensor 40 after the time frame has elapsed, the sale will be recorded as a failed sale and stored within the recorded sales data 22, as shown in FIG. 5A. Following the steps 210 and 212, the WPOSI system 10 will return to step 202.

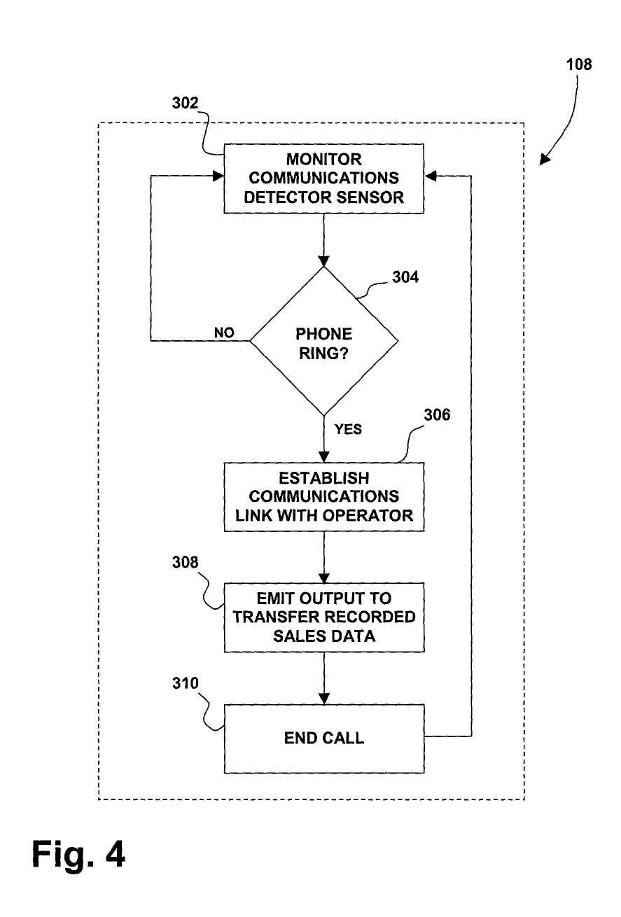

Referring now to FIG. 4, a flow chart illustrates in further detail the step 108 of establishing a communications link of FIG. 2. According to step 302, the communications detector sensor 26 monitors the wireless device 16 in order to detect a communications signal from the ringing of the wireless communications device 16. According to step 304, if the wireless communications device 16 is ringing, the controller 12 will reach the step 306.

According to the step 306, a communications link is established between the operator and the WPOSI system 10 by the controller processing unit 20 answering the communications signal from the wireless communications device 16.

According to step 308, sound playback data as stored at 30 of FIG. 1 will be emitted by the output emitter 28 to transfer the recorded sales data 22 recorded by the controller processing unit 20. The sound playback data may be under various forms. In a first embodiment, the sound playback data may be recorded voice snippets, as shown in FIG. 5, such that an operator may dial-up the WPOSI system 10 and have the sales data recited by way of these voice snippets. The controller processing unit 20 will combine the data of FIGS. 5A and 5B to provide a typical sales data prompt which goes as follows: “Five Snickers® sold”. With such sales data prompts, the vending machine operator may access the sales data by simply establishing a communications link with the WPOSI system 10. If the wireless communications device 16 is a cellular phone, the operator may access the WPOSI system 10 through PSTN. The sales data can be configured in such a manner that higher volume sales are mentioned earlier in the sequence. For example if 20 items of one particular item are sold this should be listed before lesser sales are mentioned.

In a second embodiment, the sound playback data is decoded on the operator end by a device adapted therefor, as will be explained below. For instance, the sound playback may be tones (e.g. DTMF), voice snippets or the like.

According to 310, once the recorded sales data 22 has been transferred, the call will be terminated. As an example, once the sales data have been recited by the WPOSI system 10, a message prompt recorded beforehand may be played, such as: “End of inventory”.

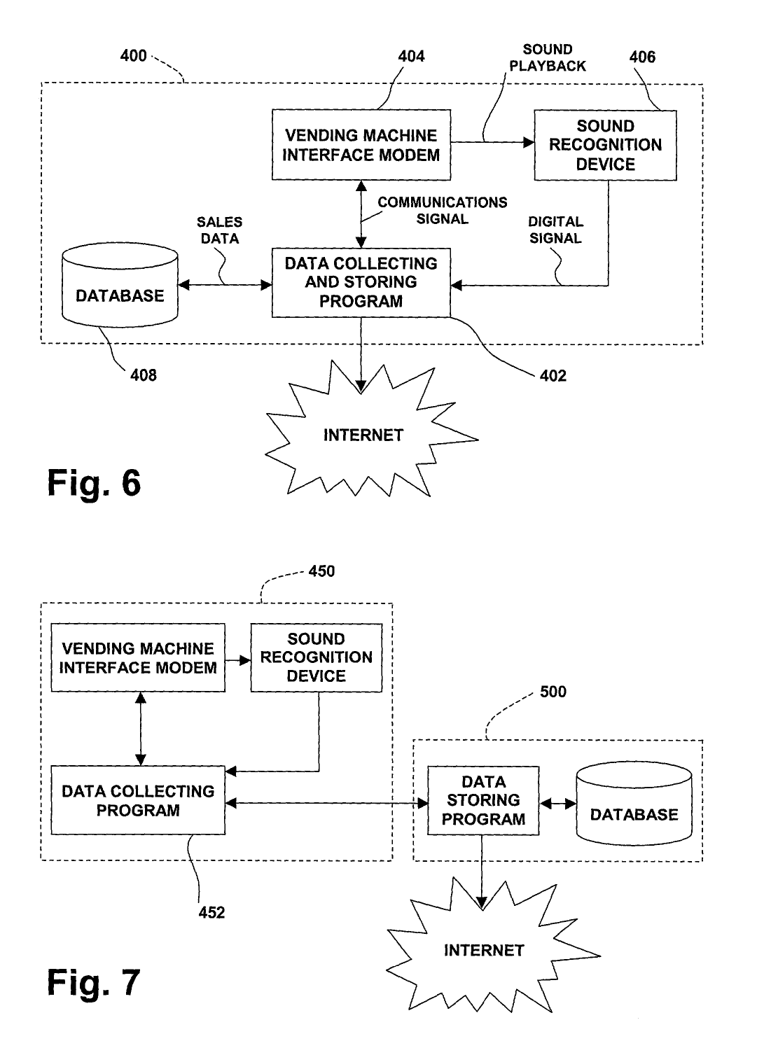

According to the second embodiment of the present invention, a computer may receive the sound playback data output from the WPOSI system 10 through the wireless communications device 16. FIG. 6 illustrates a data collecting and storing computer at 400. The data collecting and storing computer 400 runs a data collecting and storing program 402. The computer 400 also comprises a vending machine interface modem 404 (e.g. using TAPI). The modem 404 is preferably a high quality modem with extended voice modem features, so as to be more powerful and to provide a higher quality access to voice information over the phone line than a standard modem. The data collecting program 402 periodically calls the WPOSI system 10 of the vending machine, by sending a communications signal through the vending machine interface modem 404 in order to establish a communications signal with the controller processing unit 12 described above.

Once the communications link is established, the controller processing unit 12 will transfer its stored sales operations data through its output emitter 28 to the data collecting and storing computer 400, which may optionally comprise a sound recognition device 406. The latter is adapted for interpreting sales data as emitted by the WPOSI system 10. For instance, the sound recognition device 406 may transform analogue sound playbacks, (i.e. voice snippets) to digital signals in order to be stored as sales data in the database 408. On the other hand, sound playbacks of specific forms (e.g. DTMF tones, and the like) may also be transformed to a digital signal through the modem 404, in which case a sound recognition device is not required. As illustrated, the data collecting and storing computer 400 may be connected to the Internet in order for the sales data to be available to an operator through, for instance, a web site. It is pointed out that the sales data may be posted as statistical illustrations, such as graphs, in order to facilitate the interpretation of the sales operations. The storage of sales data and sales operation can be limited or disabled by each individual user according to their preferences.

The website can also track sales patterns as well as provide statistical analyses of sales of specific items of specific locations. A summary report of all past sales in a given a period can also be provided. The website may also be configured by each individual user to send SMS (Short Message Service) text messages to the wireless communications device 16, when the latter is for instance a PCS phone, in the case of deficiencies or failed sales detected by the WPOSI system 10. Also, the website may be configured to automatically send emails in response to a sales update.

Referring now to FIG. 7, a data storing computer is generally shown at 500, which may be advantageously used when a plurality of vending machines are operated. The data storing computer 500 is a file server to a plurality of data collecting computers 450 (only one of which is shown) each connected thereto. The data collecting computer 450 runs a data collector program 452 which executes similar steps than the data collecting and storing program 402, save for the storing of sales data, which is achieved by a data storing program 502 within the data storing computer 500. The data collecting computer 500 thus comprises similar components to the data collecting and storing computer 400 illustrated in FIG. 6, excluding the database. The sales data is transferred from the data collecting computer 450 to the data storing computer 500 through the data collecting program 452.

The data storing computer 500 runs the data storing program 502 and has a database 504 to store the sales data. The data storing computer 500 is preferably connected to the Internet in order to provide access to the sales data to the vending machine operators. Once more, the sales data may be treated in order to represent statistical illustrations. It has also been thought to have the data storing program 502 send a warning e-mail to an operator if the inventory within the vending machine reach a predetermined low value.

The WPOSI system 10 of the above described embodiments presents the advantage of being affordable by small-scale operators, yet is adaptable to be used with large-scale operators. For instance, the WPOSI system 10 having voice snippets recorded as sound playback data 28 is more conveniently used by a small-scale operator, who won't need to have a computer for accessing the information. On the other hand, large-scale operators are more likely to invest in WPOSI systems having data collecting and storing computers.

Another advantage of the WPOSI system 10 of the present invention resides in that it is interfaced to the vending machines through the wires of the motor array. As independent wires to the actuation of each rack is a constant amongst most newer and older vending machine, the WPOSI system 10 of the present invention is readily useable with most vending machines.

The device can communicate using a cellular phone and playing tones into the microphone input of this phone and can determine communication link by monitoring the ringing heard in the speaker output of the phone.

The device can also communication through an RS232 port which is an industry standard and can connect to hundreds of commercially available communication devices such as modem, wireless modems, GSM devices, Ethernet device.

The RS232 port can also be used to communicate to a handheld PDA or laptop of desktop computer and many of the device's features can be programmed in this manner.

The device can be configured to playback the slot sales in the following manner: “Slot one, two items sold, Slot four, three items sold . . . ” But can also allow the operator to program the name of each slot using their voice in which case the device would read “Two Snickers® Sold, Three Mars® Sold.

The device can be configured to group certain sales racks together. For example if Mars® is placed in three different racks the device can be programmed to recognize this and aggregate the sales data when prompted.

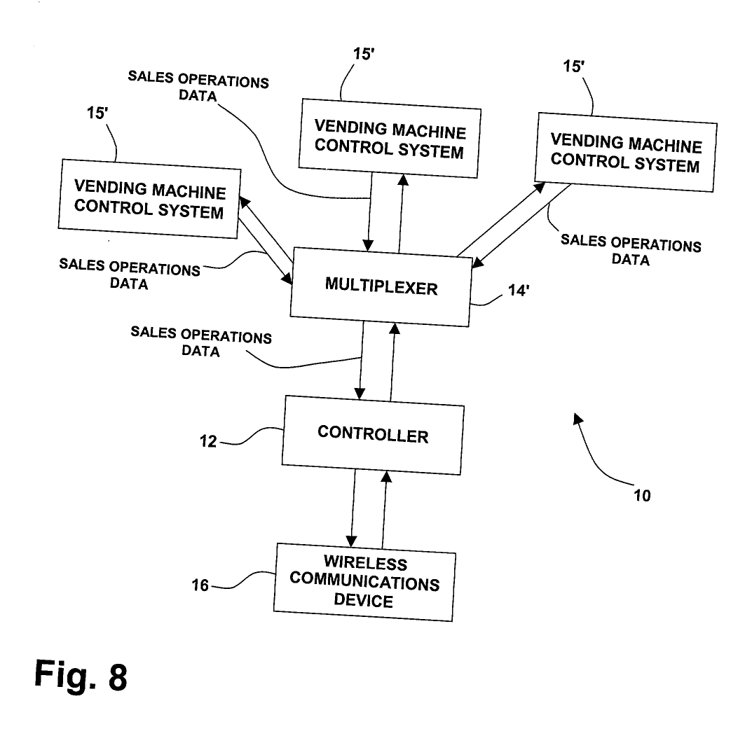

Referring to FIG. 8, another embodiment of the WPOSI system 10 is illustrated at 10′. The WPOSI system 10′ has a controller 12 and a wireless communications device 16 as described above for the WPOSI system 10. Instead of being connected to sensor devices 14, the controller 12 is connected to a multiplexer 14′. The multiplexer 14′ will enable the controller 12 to gather sales operations data from a plurality of vending machines. These vending machines are of the more recent generation of vending machines, each having a vending machine control system 15′ that controls the operations of the machine. Such control systems 15′ usually have a standard port (i.e., DEX port) over which they can transmit sales operations data. This data can be transmitted using a communications protocol known as DEX protocol.

The WPOSI system 10′ may thus gather global sales operations data in the controller 12, which may be provided with an additional external memory chip for these supplemental functions. On the other hand, an operator may access the control systems 15′ of each vending machine to access the individual sales operation data. Obviously, vending machines interconnected by the WPOSI system 10′ must be within a certain range from one another and from the controller 12 for wire connections therebetween.

I claim:

1. A method for transferring recorded sales operations data of a vending machine to a remote operator, comprising the steps of:
(i) detecting, at at least one vending machine, sales operations and recording sales operations data of said at least one vending machine;
(ii) answering a call signal from an operator; and
(iii) transferring said sales operations data of at least one rack of said at least one vending machine to said operator.

2. The method according to claim 1, wherein step (iii) includes transferring said sales operations data by sound playback.

3. The method according to claim 1, wherein step (ii) includes establishing a wireless communications link with the operator.

4. The method according to claim 3, wherein step (iii) includes transferring said sales operations data by sound playback.

5. The method according to claim 1, wherein the detecting in the step (i) is effected by monitoring actuation of motors of racks of the vending machine.

6. The method according to claim 5, wherein the step (i) includes validating a detected sales operation prior to recording sales operation data.

7. The method according to claim 6, wherein an invalidated detected sales operation is recorded as failed sales data.

8. The method according to claim 3, wherein the wireless communications link is effected by a cellular telephone in the vending machine.

9. The method according to claim 1, wherein the operator is a processor.

10. The method according to claim 2, wherein the sound playback consists in voice snippets.

11. An apparatus for recording sales operations of at least one vending machine at said at least one vending machine and for transferring the sales operations to a remote operator, comprising:
sensor devices adapted to be mounted to at least one vending machine for signaling sales operations of the vending machine;
a controller connected to said sensor devices for recording sales operations data of said at least one vending machine by receiving sales operations signaling from said sensor devices, said controller comprising an output emitter device for transferring the recorded sales operations data to a remote operator through a communications link therewith; and
a communications device for establishing the communications link between said controller and the operator.

12. The apparatus according to claim 11, wherein the recorded sales operations data are transferred to the remote operator by sound playback.

13. The apparatus according to claim 11, wherein the communications device is a wireless communications device.

14. The apparatus according to claim 13, wherein the wireless communications device is a cellular telephone and the communications link is through a public switched telephone network.

15. The apparatus according to claim 11, wherein the sensor devices include first detectors monitoring actuation of motors of racks of the vending machine for detecting said sales operations.

16. The apparatus according to claim 15, wherein the first detectors are opto-relays.

17. The apparatus according to claim 15, wherein the sensor devices further include at least a second detector monitoring a discharge of an item of the vending machine for validating said sales operations detected by the first detectors.

18. The apparatus according to claim 17, wherein the second detectors are one of a mechanical switch and an infrared beam.

19. The apparatus according to claim 12, wherein the output emitter device emits recorded voice snippets.

20. An apparatus for recording sales operations of at least two vending machines at one of said at least two vending machines and for transferring the sales operations to a remote operator, each of said at least two vending machines having a control system recording sales operations of a respective one of said at least two vending machines, comprising:
a controller connected to each said at least two vending machines for recording sales operations data of said at least two vending machines by receiving sales operations signaling from said at least two vending machines, said controller comprising an output emitter device for transferring the recorded sales operations data to a remote operator through a communications link therewith; and
a communications device for establishing the communications link between said controller and the operator.

21. The apparatus according to claim 20, wherein said controller is connected to each said at least two vending machines by a multiplexer device.

22. The apparatus according to claim 20, wherein the recorded sales operations data are transferred to the remote operator by sound playback.

23. The apparatus according to claim 20, wherein the communications device is a wireless communications device.

24. The apparatus according to claim 23, wherein the wireless communications device is a cellular telephone and the communications link is through a public switched telephone network.

25. The apparatus according to claim 22, wherein the output emitter device emits recorded voice snippets.
